(19) United States
(12) Patent Application Publication
(10) Pub. No.: US 2007/0144860 A1
(43) Pub. Date: Jun. 28, 2007

(54) Transfer case with moving coil clutch actuator operator

(75) Inventors: Thomas C. Bowen, Rochester Hills, MI (US); Jin S. Kim, Novi, MI (US)

Correspondence Address: PURDUE LAW OFFICES;2735 N. HOLLAND-SYLVANIA ROAD, SUITE B-2, TOLDEO, OH, 43615, US

(73) Assignee: DYMOS Co., Ltd d/b/a DYMOS of America, Farmington Hills, MI (US)

(21) Appl. No.: 11/315,693

(22) Filed: Dec. 22, 2005

(51) Int. Cl. F16D 27/115

(52) U.S. Cl. 192/70.23

(57) ABSTRACT

A new transfer case with a new and improved clutch actuator and operator is disclosed. The operator is operably connected to a first element of a ball ramp type transfer case clutch actuator that can be rotated, relative to a second element of the clutch actuator, to effect or release compression in the disk pack of the transfer case clutch. The operator comprises a moving coil linear actuator having a stationary magnet and a coil that is mounted adjacent to the stationary magnet for reciprocating movement which is controlled by controlling the flow of current through the coil. Linear movement of the coil is translated into rotational movement of the first element of the clutch actuator by a connecting rod.

### FIELD OF THE INVENTION

This invention relates to a power transfer mechanism of the type known as a transfer case in which torque is selectively transmitted through a friction engagement device. More particularly, the present invention relates to an operator for actuating a torque transfer case clutch disk pack compression mechanism, such as a ball ramp mechanism, that selectively causes engagement of the disk pack friction elements of the clutch for torque transmission.

### BACKGROUND OF THE INVENTION

Automotive transfer cases are used in vehicles with four wheel drive to distribute torque to front and rear axles. Some transfer cases that do not provide full time four wheel drive are equipped with friction engagement devices that are selectively actuated to cause the transmission of torque to the axle(s) for the wheels that are not full time drive wheels. Typically, such friction engagement devices include disk packs that transmit torque when subjected to axial compression, that do not transmit torque when uncompressed and transmit some torque when partially compressed. U.S. Pat. No. 6,561,332 references U.S. Pat. No. 5,499,951 which discloses a driveline transfer case where the torque split is controlled by a ball ramp clutch actuator. The transfer case disclosed in this patent includes an electromagnetic actuator for a friction clutch including a stationary magnetic coil 72 which is surrounded by a soft iron rotor 74. The rotor is drivingly coupled to an inner ring 76 that is part of a ball ramp clutch actuator. The electromagnetic actuator causes relative rotation between two ball ramp actuator components and that rotation is translated into axial compression or decompression of the disk pack.

In addition to electromagnetic type actuators, rotation of one portion of a ball ramp actuator relative to another portion has been carried out in prior art transfer cases with motor driven worm gear assemblies. An example is shown in U.S. Pat. No. 6,099,430.

### SUMMARY OF THE INVENTION

The present invention provides a new transfer case with a new and improved clutch actuator operator that is faster and more responsive than prior art clutch actuator operators. The operator is operably connected to an element of a clutch actuator that can be rotated, relative to another element of the clutch actuator, to effect or release compression in a transfer case disk pack. The operator comprises a stationary field assembly and a coil that is selectively energizable to cause relative linear movement between the field assembly and the coil. Such operators are not new and they are available commercially today. They are sometimes called moving coil actuators or voice coil actuators. What is new is the combination of a moving coil actuator and a ball ramp type transfer case clutch actuator to control the compression of a disk pack in a transfer case clutch. As used herein, “ball ramp type transfer case clutch actuator” refers to an actual ball ramp transfer case clutch actuator and any other transfer case clutch actuator which operates to compress or decompress a clutch pack when one portion of the actuator is rotated relative to another portion. According to the invention, a connector rod is secured to and supported on the coil and a portion of the connector is connected to a part of a ball ramp type transfer case clutch actuator to cause relative rotation between that part and another part of the actuator to effect compression or decompression of the disk pack of the clutch. What is also new is the unprecedented responsiveness of the combined actuator assembly and the advantages that are possible when the assembly is combined with suitable controllers, which are not the subject of this application, to prevent wheel slip and achieve traction control.

Accordingly, it is an object of the present invention to provide an improved clutch disk pack actuator including a moving coil operator combined with a ball ramp type transfer case clutch actuator.

It is another object of the invention to provide a ball ramp type transfer case clutch actuator including a moving coil type operator which is more responsive and faster acting than prior art transfer case clutch actuators.

It is a still further object of this invention to provide an improved transfer case.

These and other objects and advantages of the present invention will become apparent from a consideration of the following specification considered together with the attached drawing Figures.

### BRIEF DESCRIPTION OF THE DRAWING FIGURES

FIG. 1 is a perspective view of a transfer case according to the present invention including a moving coil operator.

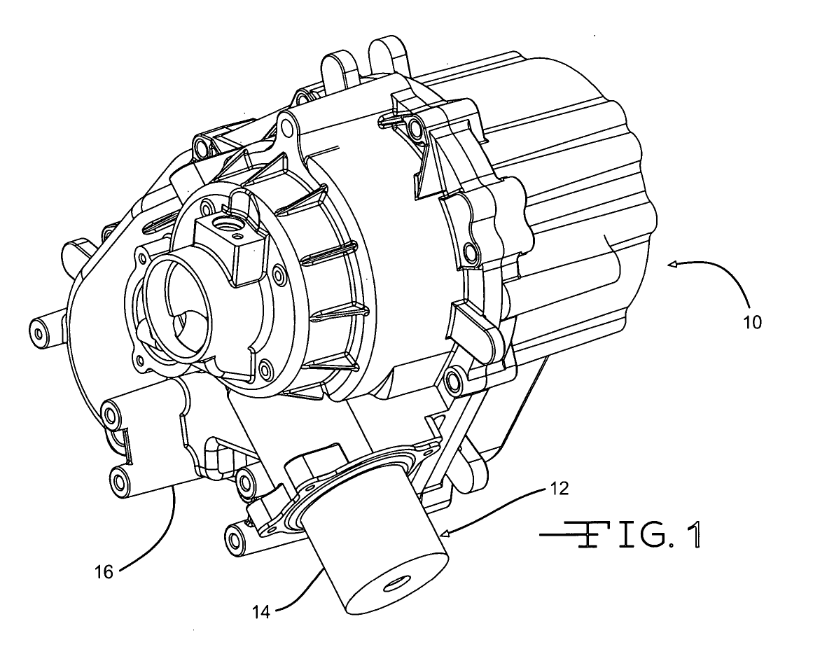

FIG. 2 is a front view of the transfer case shown in FIG. 1.

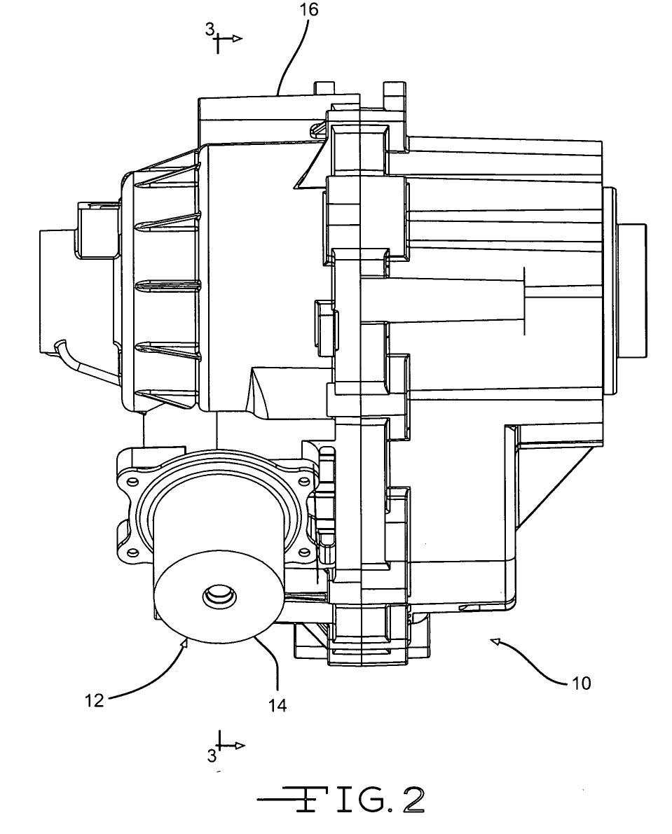

FIG. 3 is a view, partially in cross section, taken along the line 3-3 of FIG. 2, with the operator in a retracted position.

FIG. 4 is a view, partially in cross section, corresponding with FIG. 3 except that the operator is shown in FIG. 4 in an extended position.

FIG. 5 is a composite view, partially in cross section, showing the interior of the transfer case.

FIG. 6 is a perspective view of the clutch pack actuator including a ball ramp type transfer case clutch actuator and a moving coil operator according to the present invention with the operator in a retracted position.

FIG. 7 is a perspective view of the clutch pack actuator shown in FIG. 6 except that the operator is shown in an extended position.

### DETAILED DESCRIPTION OF THE PREFERRED EMBODIMENT

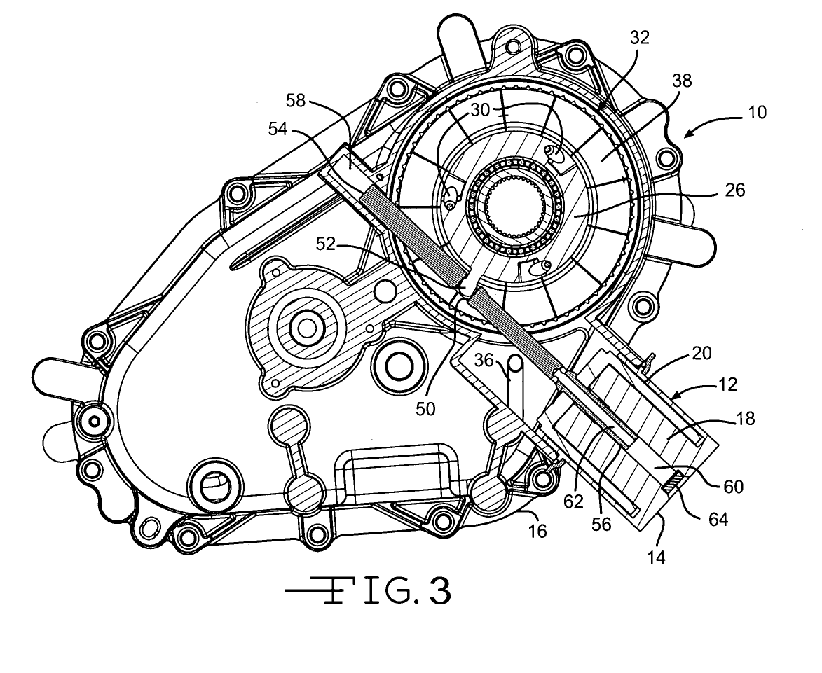

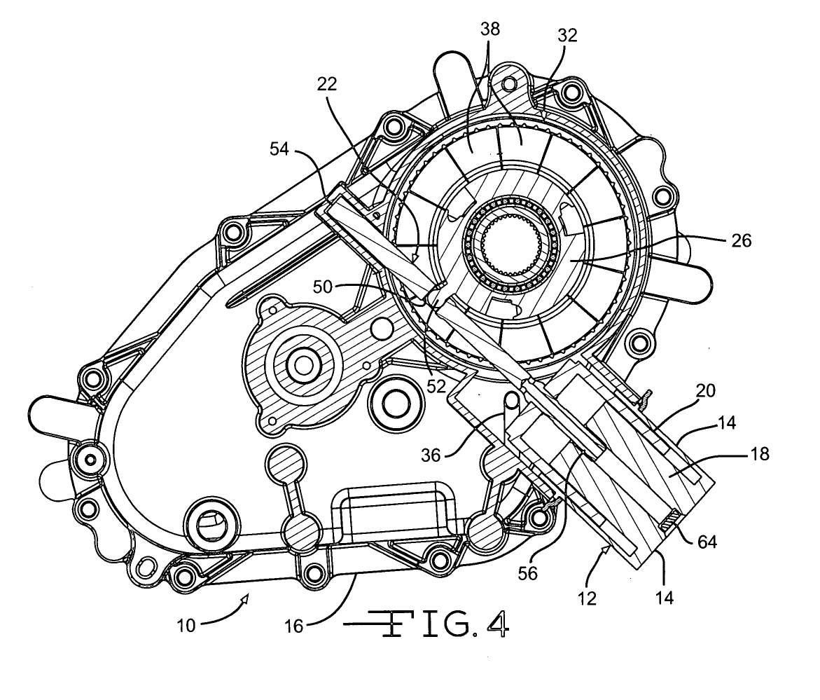

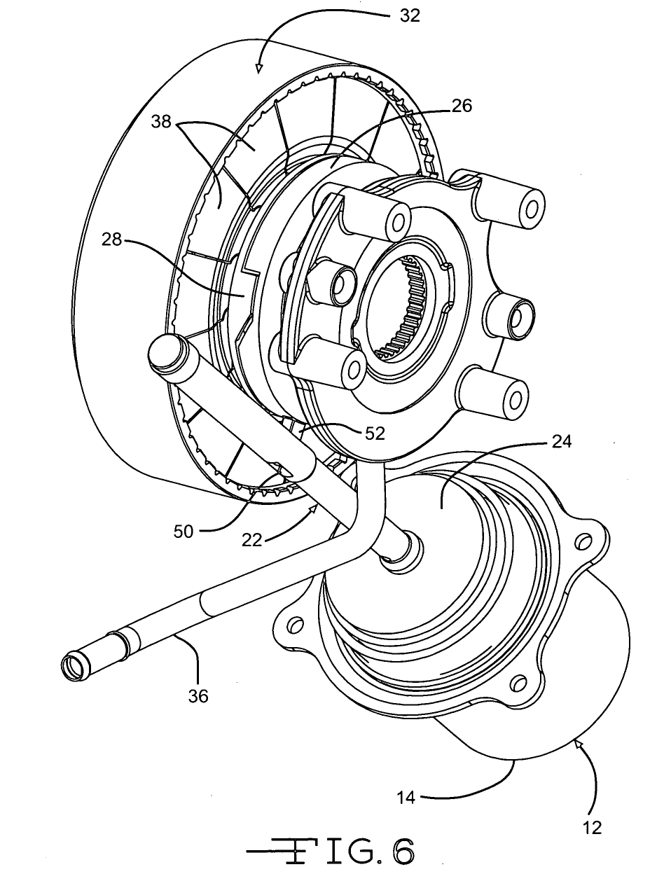

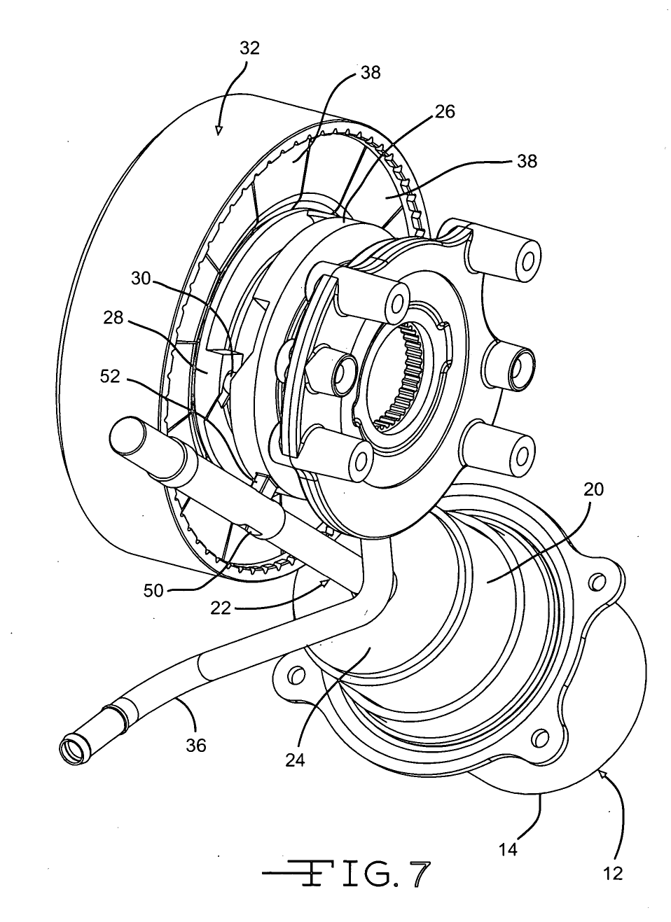

Referring now to the several drawing Figures in which like reference numerals have been used throughout to refer to like parts, a transfer case including a new actuator operator according to the present invention is indicated generally at 10. The transfer case 10 comprises an operator 12 with a housing 14 which is secured to a housing 16 of the transfer case 10. Inside of the housing 14, the operator 12 comprises a stationary field assembly 18 and a moving coil 20. The field assembly 18 includes a permanent magnet and the coil 20 is wound with wire so that, when it is energized with electric current, magnetic forces are generated in the moving coil 20 causing relative movement between the field assembly 18 and the moving coil 20. The moving coil 20 is movable by the generated forces between a first retracted position shown in FIG. 3 and FIG. 6, and a second, extended position shown in FIG. 4 and FIG. 7. A control rod 22 is secured to and supported in an end cap 24 that is part of the moving coil 20. The control rod 22 moves under the generated forces between a first retracted position shown in FIG. 3 and FIG. 6, and a second, extended position shown in FIG. 4 and FIG. 7.

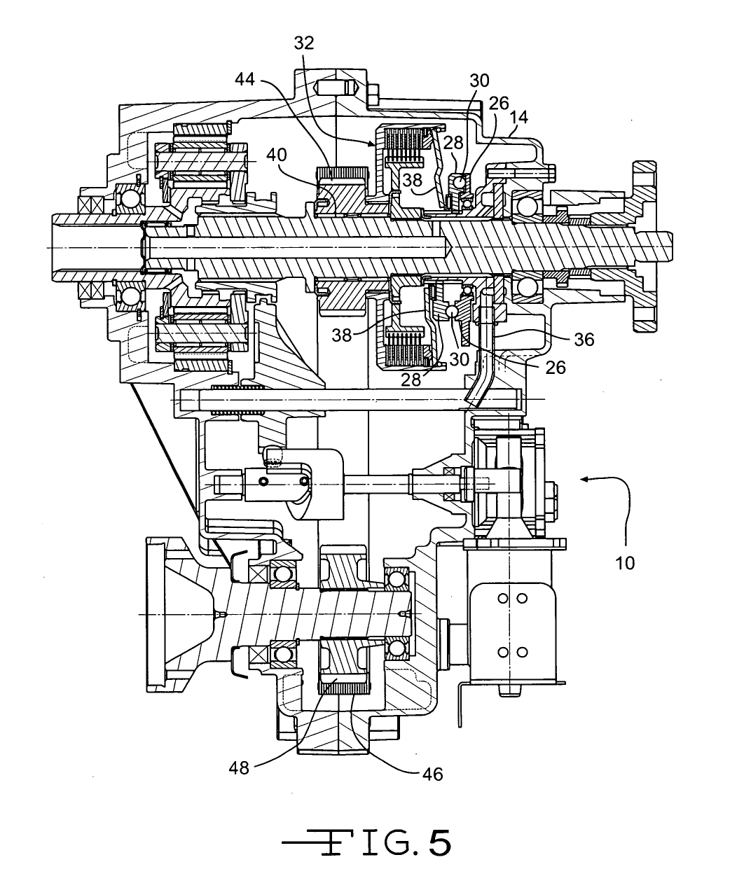

The control rod 22 is operably connected to a first ball ramp member 26 that cooperates with a second ball ramp member 28 and a plurality of bearing balls 30 which can be seen in FIGS. 3, 5 and 7 in a known manner, when member 26 is rotated relative to the member 28, to compress or decompress the friction elements in a transfer case clutch assembly indicated at 32. The first and second ball ramp members 26 and 28 are positioned between the clutch assembly 32 and an oil pump assembly indicated at 34. The ball ramp member 26 is adjacent to the oil pump assembly 34 which draws oil through a standpipe 36 from the bottom of the transfer case housing 16 and distributes it, in known fashion, to the hard parts of the transfer case 10. The ball ramp member 28 is adjacent to clutch actuation levers 38 and it is fixed against rotation. Rotation of the member 26, which is fixed against axial movement, causes axial movement of the ball ramp member 28 between a first, retracted position shown in FIGS. 3 and 6 and in FIG. 5 above a shaft 40. When the member 28 is in this position, it does not act to compress the friction elements of the clutch assembly 32 through a pressure plate 42. When rotation of the member 26 causes axial movement of the member 28 into an extended position, as shown in FIGS. 4 and 7 and below the shaft 40 in FIG. 5, the member 28 causes the pressure plate 42 to compress the friction elements of the clutch assembly 32 so that torque is transmitted through the clutch to a chain sprocket 44 and from there, through a chain 46 to a chain sprocket on an output shaft 48. Selective actuation of the ball ramp type transfer case clutch actuator is key to on demand four wheel drive and selective variable actuation of the actuator is key to traction control and the prevention of wheel slippage.

Referring now to FIGS. 3, 4, 6 and 7, it will be seen that a recess in the form of a transverse slot 50 is provided in the control rod 22. A projection 52 on ball ramp member 26 extends radially outwardly from the member 26 and is received in the slot 50. The member 26 is mounted for rotation about the common axis of the members 26 and 28, the clutch assembly 32 and the oil pump assembly 34. Linear movement of the control rod 22 is translated by the projection 52/slot 50 connection into rotational movement of the member 26 which, as described above, will either cause compression of or release compression of the friction elements of the clutch assembly 32. An end 54 of the rod 22 that is remote from the other end 56 of the rod 22 is received in a rod recess 58 formed in the interior of the transfer case housing 16. The end 56 of the rod 22 is received within an axially extending passageway 60 formed in the field assembly 18 of the operator 12. An axially extending passageway 62 is provided within the rod 22 providing communication between the passageway 60 in the field assembly 18 and the interior of the transfer case housing 16. A cap 64 closes the field assembly passageway 60.

It will be appreciated that there are intermediate positions for the rod 22 between the extended position shown in FIGS. 4 and 7 and the retracted position shown in FIGS. 3 and 6 and these intermediate positions will be associated with more or less axial compressive force exerted by the ball ramp member 28 on the disk pack of the clutch assembly 32, with more or less torque being transmitted through the clutch assembly 32. Thus, the combination of the operator 12 and the ball ramp type transfer case clutch actuator can control not only whether or not torque is transmitted through a friction engagement device such as the clutch 32, but also how much torque is transmitted therethrough.

The operator 12, as previously mentioned, is a moving coil type of linear actuator. Also known as a voice coil, the operator 12 is a direct drive limited motion type of device that utilizes a permanent, stationary magnet field and a reciprocating coil to produce a force that is proportional to the current applied to the coil. In a moving coil actuator, the conversion of electricity to mechanical force is governed by the Lorentz Force Principle. The force generated in a linear moving coil actuator is linearly proportional to the current applied to the coil. Although the operator 12 is illustrated as having a cylindrical coil, “flat” linear voice coil actuators are also available and they have a coil that is rectangular in cross section. These and other voice coil linear actuators are especially suited for use in the present invention with a ball ramp type transfer case clutch actuator.

While the foregoing description sets forth very specific details about the construction and components of a transfer case clutch actuator according to the present invention, it is presented only to enable one having ordinary skill in the art to practice the invention and is not to be construed as limiting the true scope of the present invention.

I claim:

1. A transfer case comprising
a housing
a clutch with a compressible disk pack,
a ball ramp type transfer case clutch actuator having a first member that is rotatable relative to a second member and wherein relative rotation between the members in a first direction is operable to compress the disk pack for torque transmission through the clutch,
an operator for causing relative rotation between said first and second members of said ball ramp type transfer case clutch actuator, said operator comprising
at least one stationary magnet that is supported in a stationary manner relative to said housing,
a coil that is supported for reciprocating movement in the field of the at least one stationary magnet so that it is in a first position when no current is flowing through said coil and, when current is allowed to flow through said coil, said coil is acted upon by a force that tends to move said coil linearly, relative to said at least one stationary magnet, to a second position, and
a connector rod connecting said coil to said first member so that linear force acting on said coil when current is allowed to flow therethrough is translated into rotational force tending to rotate said first member relative to said second member.

2. The transfer case claimed in claim 1 wherein said ball ramp type transfer case clutch actuator is a ball ramp transfer case clutch actuator.

3. The transfer case claimed in claim 1 wherein said coil has a circular cross section.

4. A transfer case comprising
a housing
a clutch with a compressible disk pack,
a ball ramp type transfer case clutch actuator having a first member that is rotatable relative to a second member and wherein relative rotation between the members in a first direction is operable to compress the disk pack for torque transmission through the clutch, said first member having a projection,
an operator for causing relative rotation between said first and second members of said ball ramp type transfer case clutch actuator, said operator comprising
at least one stationary magnet that is supported in a stationary manner relative to said housing,
a coil that is supported for reciprocating movement in the field of the at least one stationary magnet so that it is in a first position when no current is flowing through said coil and, when current is allowed to flow through said coil, said coil is acted upon by a force that tends to move said coil linearly, relative to said at least one stationary magnet, to a second position, and
a connector rod that is connected to said coil for movement therewith, said connector rod having an opening in which said projection is received so that linear force acting on said coil when current is allowed to flow therethrough is translated by said rod into rotational force tending to rotate said first member relative to said second member.

5. The transfer case claimed in claim 4 wherein said ball ramp type transfer case clutch actuator is a ball ramp transfer case clutch actuator.

6. The transfer case claimed in claim 4 wherein said coil has a circular cross section.

7. A transfer case comprising
a housing
a clutch with a compressible disk pack,
a ball ramp type transfer case clutch actuator having a first member that is rotatable relative to a second member and wherein relative rotation between the members in a first direction is operable to compress the disk pack for torque transmission through the clutch, said first member having an axially extending projection,
an operator for causing relative rotation between said first and second members of said ball ramp type transfer case clutch actuator, said operator comprising
at least one stationary magnet that is supported in a stationary manner relative to said housing,
a coil that is supported for reciprocating movement in the field of the at least one stationary magnet so that it is in a first position when no current is flowing through said coil and, when current is allowed to flow through said coil, said coil is acted upon by a force that tends to move said coil linearly, relative to said at least one stationary magnet, to a second position, and
a connector rod that is connected to said coil for movement therewith, said connector rod having a transversely extending slot in which said axially extending projection is received so that linear force acting on said coil when current is allowed to flow therethrough is translated by said rod into rotational force tending to rotate said first member relative to said second member.

8. The transfer case claimed in claim 7 wherein said ball ramp type transfer case clutch actuator is a ball ramp transfer case clutch actuator.

9. The transfer case claimed in claim 1 wherein said coil has a circular cross section.
